(19) United States
(12) Patent Application Publication
(10) Pub. No.: US 2026/0088228 A1
(43) Pub. Date: Mar. 26, 2026

(54) MULTILAYER CERAMIC COMPONENT

(71) Applicant: Murata Manufacturing Co., Ltd., Nagaokakyo-shi (JP)

(72) Inventors: Hiroyuki WATANABE, Nagaokakyo-shi (JP); Kenichi HAYASHI, Nagaokakyo-shi (JP); Toshihiro SUZUKI, Nagaokakyo-shi (JP)

(73) Assignee: Murata Manufacturing Co., Ltd., Nagaokakyo-shi (JP)

(21) Appl. No.: 19/408,412

(22) Filed: Dec. 4, 2025

Related U.S. Application Data
(63) Continuation of application No. PCT/JP2024/014055, filed on Apr. 5, 2024.

(30) Foreign Application Priority Data
Jun. 12, 2023 (JP) 2023-096085

(51) Int. Cl. H01G 4/232; H01G 4/30

(52) U.S. Cl. CPC H01G 4/2325; H01G 4/30

(57) ABSTRACT

A multilayer ceramic component in which an external electrode has a thickness that does not inhibit ease of mounting. This multilayer ceramic component includes external electrodes. The external electrodes each include: a base film that extends to a first main surface and a second main surface and in contact with the internal electrode layers; an inner plating film in contact with the base film; and an outer plating film in contact with the inner plating film. The base film has a thickness that is 1.4 to 3.0 times the film thickness of the inner plating film and is 1.4 to 3.0 times the film thickness of the outer plating film. The film thickness of the base film is 0.4 to 0.6 times the total film thickness of the base film, the inner plating film and the outer plating film.

### CROSS-REFERENCE TO RELATED APPLICATIONS

The present application is a continuation of PCT International Application No. PCT/JP2024/014055, filed on Apr. 5, 2024, which claims priority to Japanese patent application JP 2023-096085, filed Jun. 12, 2023, the entire contents of each of which being incorporated herein by reference.

### TECHNICAL FIELD

### Field

The present disclosure relates to multilayer ceramic components, particularly to multilayer ceramic capacitors.

### Background Art

In multilayer ceramic capacitors, external electrodes each include a base electrode and plating films, and the plating films include a Ni plating film covering the base electrode and a Sn plating film covering the Ni plating film. The base electrode, the Ni plating film, and the Sn plating film have constant thicknesses.

### CITATION LIST

### Patent Document

Patent Document 1: Japanese Unexamined Patent Application, Publication No. 2020-174110

### SUMMARY

### Problems to be Solved

In Patent Document 1, the base electrode layer is designed with sufficient thickness in order to ensure the connection reliability with internal electrode layers provided inside the multilayer body, the Ni plating film covering the base electrode layer is designed with sufficient thickness in order to prevent solder leaching during mounting, and the Sn plating film covering the Ni plating film is designed with sufficient thickness in order to ensure solder wettability.

However, in recent years, the housings in which multilayer ceramic capacitors are mounted have been reduced in size, and in the housings that have been reduced in size, the area where multilayer ceramic capacitors can be mounted has decreased. Reducing the size of the inner layer portion in order to reduce the size of each of the multilayer ceramic capacitors to correspond to the mountable area of each of the housings that have been reduced in size makes it difficult to ensure desired capacitance. Therefore, the thicknesses of the base electrode layer, Ni plating film, and Sn plating film, which do not contribute to capacitance formation, have become an issue for mountability to reduced-size housings.

Therefore, the present disclosure is directed to providing multilayer ceramic capacitors, each having an external electrode thickness that ensures connection reliability and does not impair mountability, even when a housing in which the multilayer ceramic capacitors are mounted is reduced in size. Means for Solving the Problems

An embodiment of the present disclosure provides a multilayer ceramic component which includes: a multilayer body including a plurality of dielectric layers and a plurality of internal electrode layers that are laminated, a first main surface and a second main surface opposed to each other in a lamination direction, a first lateral surface and a second lateral surface opposed to each other in a width direction orthogonal to the lamination direction, and a first end surface and a second end surface opposed to each other in a length direction orthogonal to the lamination direction and the width direction; and external electrodes each provided on a corresponding one of the first end surface and the second end surface, and connected to the plurality of internal electrode layers. The external electrodes each extend to the first main surface and the second main surface. The external electrodes each include a base film in contact with the plurality of internal electrode layers, an inner plating film in contact with the base film, and an outer plating film in contact with the inner plating film. A film thickness of the base film is greater than a film thickness of the inner plating film or the outer plating film. The film thickness of the base film is 1.4 times or more and 3.0 times or less of a film thickness of the inner plating film. The film thickness of the base film is 1.4 times or more and 3.0 times or less of a film thickness of the outer plating film. The film thickness of the base film is 0.4 times or more and 0.6 times or less of a total film thickness of the base film, the inner plating film, and the outer plating film. A film thickness of the inner plating film is 0.2 times or more and 0.3 times or less of the total film thickness of the base film, the inner plating film, and the outer plating film. A film thickness of the outer plating film is 0.2 times or more and 0.3 times or less of the total film thickness of the base film, the inner plating film, and the outer plating film.

### Effects

According to the present disclosure, multilayer ceramic components, each having an external electrode thickness that ensures connection reliability and does not impair mountability, even when a housing in which the multilayer ceramic components are mounted is reduced in size.

### BRIEF DESCRIPTION OF THE DRAWINGS

FIG. 1 is a perspective view of a multilayer ceramic component according to an embodiment of the present invention.

FIG. 2 is a cross-sectional view taken along the line I-I in FIG. 1. FIG. 3A is a cross-sectional view taken along the line IIA-IIA in FIG. 1. FIG. 3B is a cross-sectional view taken along the line IIB-IIB in FIG. 1.

### DETAILED DESCRIPTION

### Embodiment 1

Hereinafter, an example of an embodiment of the multilayer ceramic component 1 of the present disclosure will be described with reference to the accompanying drawings. In the following description, a case where the multilayer ceramic component 1 is a multilayer ceramic capacitor will be described as an example.

### (External Configuration of Multilayer Ceramic Component)

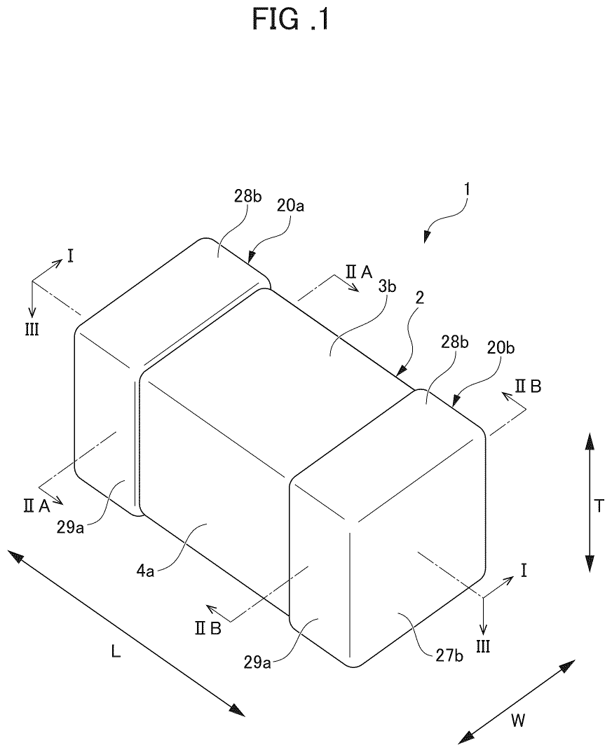

Based on FIG. 1, an overview of the external appearance of the multilayer ceramic component 1 will be described. FIG. 1 is a perspective view showing the multilayer ceramic component 1 of the present embodiment. The multilayer ceramic component 1 includes a multilayer body 2 and external electrodes 20. The external electrodes 20 include a first external electrode 20a and a second external electrode 20b.

### Definition of Directions

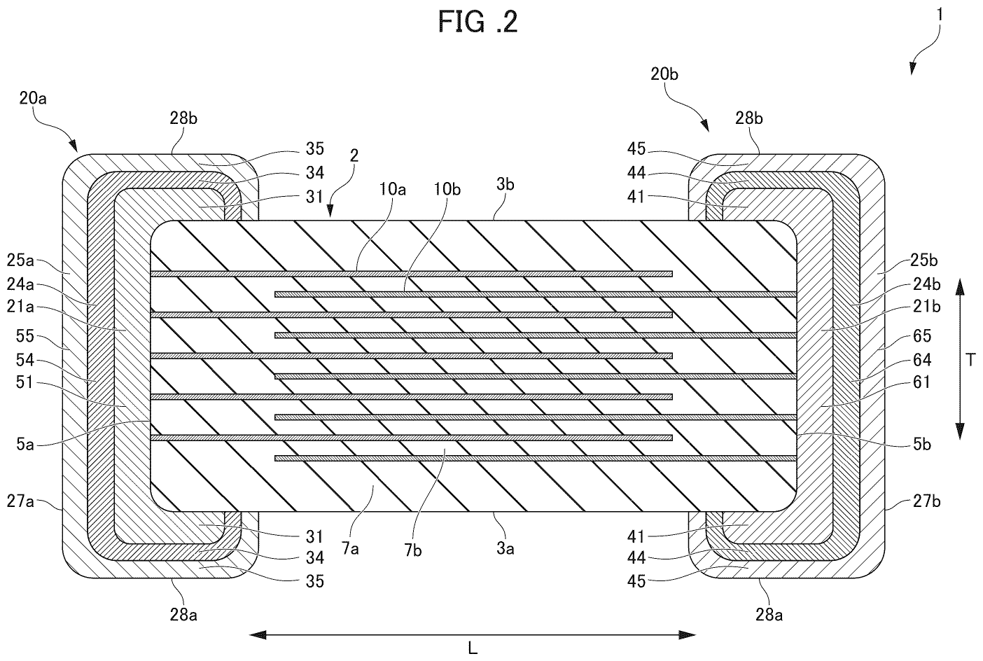

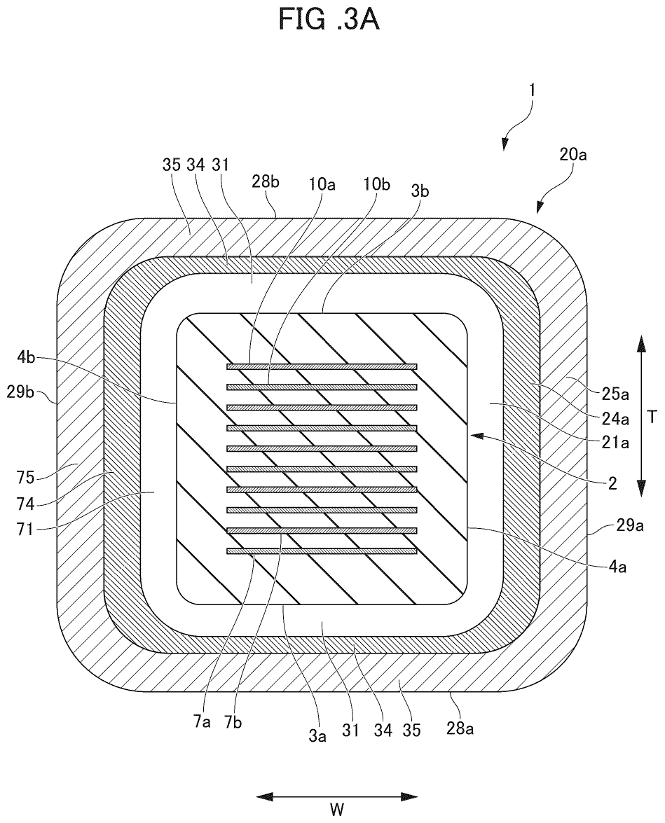

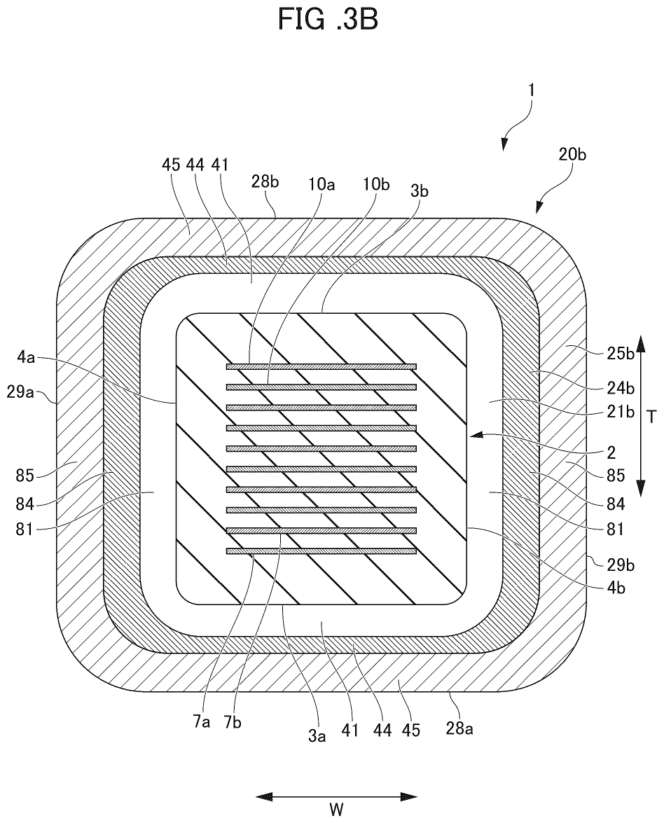

In the drawings, the L direction, the W direction, and the T direction are shown. The L direction is the length direction L of the multilayer ceramic component 1. The W direction is the width direction W of the multilayer ceramic component 1. The T direction is the lamination direction T of the multilayer ceramic component 1. With such a configuration, the cross section shown in FIG. 2 is referred to as an LT cross section, and the cross sections shown in FIGS. 3A and 3B are referred to as WT cross sections. The length direction L, the width direction W, and the lamination direction T are not necessarily in an orthogonal relationship to each other. The length direction L, the width direction W, and the lamination direction T may be in intersecting relationship with each other.

### (External Configuration of Multilayer Body)

The multilayer body 2 has a substantially rectangular parallelepiped shape. The multilayer body 2 includes two main surfaces 3, two lateral surfaces 4, and two end surfaces 5. The main surfaces 3 are surfaces opposed to each other in the lamination direction T. The lateral surfaces 4 are surfaces opposed to each other in the width direction W. The end surfaces 5 are surfaces opposed to each other in the length direction L. One of the two main surfaces 3 is defined as a first main surface 3a, and the other is defined as a second main surface 3b. One of the two lateral surfaces 4 is defined as a first lateral surface 4a, and the other is defined as a second lateral surface 4b. One of the two end surfaces 5 is defined as a first end surface 5a, and the other is defined as a second end surface 5b.

The ridge portions and the corner portions of the multilayer body 2 may be rounded. Each of the ridge portions refers to a portion where two surfaces of the multilayer body 2 intersect with each other. Each of the corner portions refers to a portion where three surfaces of the multilayer body 2 intersect with each other. The size of the multilayer body 2 is not particularly limited.

### (Configuration of Multilayer Body)

The multilayer body 2 includes a plurality of dielectric layers 7 and a plurality of internal electrode layers 10. Hereinafter, the internal configuration of the multilayer body 2 will be described with reference to cross-sectional views of the multilayer body 2.

### (Internal Configuration of Multilayer Body (LT Cross Section))

Based on FIG. 2, the internal configuration of the multilayer body 2 will be described. FIG. 2 is a cross-sectional view taken along the line I-I in FIG. 1. FIG. 2 shows an LT cross section of the multilayer ceramic component 1. In the multilayer body 2, the plurality of dielectric layers 7 and the plurality of internal electrode layers 10 are laminated with each other in the lamination direction T.

### (Dielectric Layers)

The dielectric layers 7 can be classified into outer dielectric layers 7a and inner dielectric layers 7b. The inner dielectric layers 7b are dielectric layers 7 located between the internal electrode layers 10. The outer dielectric layers 7a are dielectric layers 7 located between the first main surface 3a and the internal electrode layer 10 closest to the first main surface 3a, and between the second main surface 3b and the internal electrode layer 10 closest to the second main surface 3b.

### (Number of Dielectric Layers)

The number of dielectric layers 7 laminated in the multilayer body 2 can be, for example, 5 or more and 2000 or less. The number of dielectric layers 7 includes the number of outer dielectric layers 7a and the number of inner dielectric layers 7b.

### (Material of Dielectric Layers)

As the material of the dielectric layers 7, for example, dielectric ceramics including main components such as BaTiO₃, CaTiO₃, SrTiO₃, and CaZro₃ can be used. Also, materials obtained by adding subcomponents such as Mn compounds, Fe compounds, Cr compounds, Co compounds, and Ni compounds to these main components may be used.

### (Thickness of Dielectric Layers)

The thickness of each of the dielectric layers 7 can be, for example, 0.3 μm or more and 100 μm or less. The outer dielectric layers 7a may be a plurality of layers or may be a single layer.

### (Internal Electrode Layers)

The internal electrode layers 10 can be classified into first internal electrode layers 10a and second internal electrode layers 10b. Each of the first internal electrode layers 10a is an internal electrode layer 10 connected to the first external electrode 20a. Each of the second internal electrode layers 10b is an internal electrode layer 10 connected to the second external electrode 20b. Each of the first internal electrode layers 10a extends from the first end surface 5a toward the second end surface 5b. Each of the second internal electrode layers 10b extends from the second end surface 5b toward the first end surface 5a.

### (Counter Portion and Extension Portion)

The first internal electrode layers 10a and the second internal electrode layers 10b each include a counter electrode portion and an extension electrode portion. Each of the counter electrode portions 11 is a portion of the internal electrode layer 10 where the first internal electrode layer 10a and the second internal electrode layer 10b are opposed to each other in the lamination direction T. Each of the extension electrode portions 12 is a portion of the internal electrode layer 10 extending from the counter electrode portion toward the first end surface 5a or toward the second end surface 5b of the multilayer body 2.

The counter electrode portion of each of the first internal electrode layers 10a is referred to as a first counter electrode portion. The extension electrode portion of each of the first internal electrode layers 10a is referred to as a first extension electrode portion. Each of the first extension electrode portions 12a is a portion extending from the first counter electrode portion toward the first end surface 5a of the multilayer body 2.

Similarly, the counter electrode portion of each of the second internal electrode layers 10b is referred to as a second counter electrode portion. The extension electrode portion of each of the second internal electrode layers 10b is referred to as a second extension electrode portion. Each of the second extension electrode portions 12b is a portion extending from the second counter electrode portion toward the second end surface 5b of the multilayer body 2.

### (Number of Internal Electrode Layers)

The number of the internal electrode layers 10 may be, for example, 10 or more and 2000 or less. The number of the internal electrode layers 10 is a number including the number of the first internal electrode layers 10a and the number of the second internal electrode layers 10b.

### (Thickness of Internal Electrode Layer)

The thickness of each of the internal electrode layers 10 can be, for example, 0.1 μm or more and 5.0 μm or less, e.g., 0.2 μm or more and 2.0 μm or less. When the thickness of each of the internal electrode layers 10 is 0.5 μm or more, a plating film grows more easily when the metal layer of the external electrode 20 is formed by plating.

### (Material of Internal Electrode Layer)

The material of the internal electrode layers 10 may be, for example, a metal such as Ni, Cu, Ag, Pd, or Au, an alloy of Ni and Cu, or an alloy of Ag and Pd. The material of the internal electrode layers 10 may further include dielectric particles of the same composition as the ceramic contained in the dielectric layer 7.

### (External Electrode)

The external electrodes 20 include a first external electrode 20a and a second external electrode 20b. The first external electrode 20a is an external electrode 20 provided on the first end surface 5a of the multilayer body 2. The first external electrode 20a is electrically connected to the first internal electrode layers 10a. The second external electrode 20b is an external electrode 20 provided on the second end surface 5b of the multilayer body 2. The second external electrode 20b is electrically connected to the second internal electrode layers 10b.

### (External Electrode on Each Surface)

Each of the external electrodes 20 extends from one of the end surfaces 5 to a portion of each of the two main surfaces 3 and a portion of each of the two lateral surfaces 4. A portion of the external electrode 20 provided on the end surface 5 is referred to as an end surface external electrode 27. A portion of the external electrode 20 provided on a portion of each of the main surfaces 3 is referred to as a main surface external electrode 28. A portion of the external electrode 20 provided on a portion of each of the lateral surfaces 4 is referred to as a lateral surface external electrode 29.

### (End Surface External Electrode)

Specifically, a portion of the first external electrode 20a provided on the first end surface 5a is referred to as a first end surface external electrode 27a. Also, a portion of the second external electrode 20b provided on the second end surface 5b is referred to as a second end surface external electrode 27b.

### (Main Surface External Electrode)

A portion of each of the first external electrode 20a and the second external electrode 20b provided on a portion of the first main surface 3a is referred to as a first main surface external electrode 28a. Also, a portion of each of the first external electrode 20a and the second external electrode 20b provided on a portion of the second main surface 3b is referred to as a second main surface external electrode 28b.

### (Lateral Surface External Electrode)

The lateral surface external electrode 29 is similar to the main surface external electrode 28. A portion of each of the first external electrode 20a and the second external electrode 20b provided on a portion of the first lateral surface 4a is referred to as a first lateral surface external electrode 29a. Also, a portion of each of the first external electrode 20a and the second external electrode 20b provided on a portion of the second lateral surface 4b is referred to as a second lateral surface external electrode 29b.

### (Layer Configuration of External Electrode)

The layer configuration of the external electrode 20 will be described based on FIG. 2, FIG. 3A, and FIG. 3B. FIG. 3A is a cross-sectional view taken along the line IIA-IIA in FIG. 1, and FIG. 3B is a cross-sectional view taken along the line IIB-IIB in FIG. 1. The external electrode 20 includes a base film 21 and a plating film. The plating film includes an inner plating film 24 and an outer plating film 25. These layers are provided in the order of the base film 21, the inner plating film 24, and the outer plating film 25 from the end surface 5 of the multilayer body 2. Specifically, the first external electrode 20a includes a first base film 21a, a first inner plating film 24a, and a first outer plating film 25a. Similarly, the second external electrode 20b includes a second base film 21b, a second inner plating film 24b, and a second outer plating film 25b.

### (Base Film)

The first base film 21a includes a first main surface base film 31 provided on the first main surface 3a and the second main surface 3b of the multilayer body 2, a first end surface base film 51 provided on the first end surface 5a of the multilayer body 2, and a first lateral surface base film 71 provided on the first lateral surface 4a and the second lateral surface 4b of the multilayer body 2.

Similarly, the second base film 21b includes a second main surface base film 41 provided on the first main surface 3a and the second main surface 3b of the multilayer body 2, a second end surface base film 61 provided on the second end surface 5b of the multilayer body 2, and a second lateral surface base film 81 provided on the first lateral surface 4a and the second lateral surface 4b of the multilayer body 2.

### (Fired Layer)

The first base film 21a and the second base film 21b are configured as fired layers. The fired layer includes a glass component and a metal. The glass component includes at least one selected from B, Si, Ba, Mg, Al, Li, and the like. The metal includes, for example, at least one selected from Cu, Ni, Ag, Pd, Ag—Pd alloy, Au, and the like. The fired layer may include a plurality of layers. The fired layer is formed by applying an electrically conductive paste including a glass component and a metal to the multilayer body 2, and then firing the paste. This firing may be performed simultaneously with the firing of the internal electrode layers 10, or may be performed separately after firing the internal electrode layers 10.

### (Plating Film)

The plating film on the base film 21 will be described. As described above, in the present embodiment, the plating film includes the inner plating film 24 and the outer plating film 25. That is, the plating film includes two layers. However, the plating film may include a single layer or a plurality of layers of three or more layers.

When the plating film includes two layers, a Ni plating film and a Sn plating film may be provided in this order from the lower layer. In this case, the Ni plating film corresponds to the inner plating film 24, and the Sn plating film corresponds to the outer plating film 25.

### (Inner Plating Film)

The first inner plating film 24a includes a first main surface inner plating film 34 provided on the first main surface base film 31, a first end surface inner plating film 54 provided on the first end surface base film 51, and a first lateral surface inner plating film 74 provided on the first lateral surface base film 71.

Similarly, the second inner plating film 24b includes a second main surface inner plating film 44 provided on the second main surface base film 41, a second end surface inner plating film 64 provided on the second end surface base film 61, and a second lateral surface inner plating film 84 provided on the second lateral surface base film 81.

### (Outer Plating Film)

The first outer plating film 25a includes a first main surface outer plating film 35 provided on the first main surface inner plating film 34, a first end surface outer plating film 55 provided on the first end surface inner plating film 54, and a first lateral surface outer plating film 75 provided on the first lateral surface inner plating film 74.

The second outer plating film 25b includes a second main surface outer plating film 45 provided on the second main surface inner plating film 44, a second end surface outer plating film 65 provided on the second end surface inner plating film 64, and a second lateral surface outer plating film 85 provided on the second lateral surface inner plating film 84.

The plating films such as the inner plating film 24 and the outer plating film 25 may include at least one selected from metals such as Cu, Ni, Ag, Pd, Au, and Sn, and alloys such as Ag—Pd alloy. As described above, among these, the inner plating film 24 may be a Ni plating film, and the outer plating film 25 may be a Sn plating film. However, the inner plating film 24 and the outer plating film 25 are not limited to the Ni plating film and the Sn plating film.

The Ni plating film can prevent the base film 21 from being eroded by solder when mounting the multilayer ceramic component 1. On the other hand, the Sn plating film can improve the wettability of solder when mounting the multilayer ceramic component 1, making mounting easier. Therefore, by establishing the outer plating film 25 as a Sn plating film, it is possible to improve the wettability of solder with respect to the external electrode 20.

### (WT Cross Section Of Multilayer Body)

Based on FIGS. 3A and 3B, the WT cross section of the multilayer body 2 will be described. In the WT cross section of the multilayer body 2 at the portion where the external electrode 20 is provided, four surfaces of the multilayer body 2 are covered by the external electrode 20. Specifically, a first main surface external electrode 28a is provided on the first main surface 3a of the multilayer body 2, and similarly, a second main surface external electrode 28b is provided on the second main surface 3b, a first lateral surface external electrode 29a is provided on the first lateral surface 4a, and a second lateral surface external electrode 29b is provided on the second lateral surface 4b. The first main surface external electrode 28a, the second main surface external electrode 28b, the first lateral surface external electrode 29a, and the second lateral surface external electrode 29b are continuous.

### (Thickness of External Electrode) (Claim 1)

The multilayer ceramic component 1 of the present disclosure is characterized by the thickness of the external electrode 20. As shown in FIG. 3A and FIG. 3B, the thickness of the base film 21 is greater than the inner plating film 24 or the outer plating film 25. Specific dimensions will be described later. The dimensional ratio of each portion differs from the actual dimensional ratio.

### (Thickness of Each Layer)

As described above, the external electrode 20 includes a plurality of layers. Specifically, the external electrode 20 includes the base film 21, the inner plating film 24, and the outer plating film 25. Therefore, the thickness of the external electrode 20 is the sum of the thicknesses of each layer. In the present embodiment, as an example of the method, a method of adjusting the thicknesses of the base film 21, the inner plating film 24, and the outer plating film 25 will be described.

The base film 21 in the first main surface external electrode 28a is referred to as the first main surface base film 31. The inner plating film 24 in the first main surface external electrode 28a is referred to as the first main surface inner plating film 34. The outer plating film 25 in the first main surface external electrode 28a is referred to as the first main surface outer plating film 35.

Similarly for the second main surface external electrode 28b, the base film 21 in the second main surface external electrode 28b is referred to as the second main surface base film 41. The inner plating film 24 in the second main surface external electrode 28b is referred to as the second main surface inner plating film 44. The outer plating film 25 in the second main surface external electrode 28b is referred to as the second main surface outer plating film 45.

The thickness of the first main surface external electrode 28a corresponds to the sum of the thickness of the first main surface base film 31, the thickness of the first main surface inner plating film 34, and the thickness of the first main surface outer plating film 35. Similarly, the thickness of the second main surface external electrode 28b corresponds to the sum of the thickness of the second main surface base film 41, the thickness of the second main surface inner plating film 44, and the thickness of the second main surface outer plating film 45. The thickness of the external electrode 20 in the length direction at the first end surface and the second end surface, and the thickness of the external electrode 20 in the width direction at the first lateral surface and the second lateral surface are not illustrated with reference numerals, but correspond to similar sums of thicknesses.

### Advantageous Effects

With such a configuration, the thickness of the external electrode 20 in the lamination direction at the first main surface and the second main surface, the thickness of the external electrode 20 in the length direction at the first end surface and the second end surface, and the thickness of the external electrode 20 in the width direction at the first lateral surface and the second lateral surface are each small, such that it is possible to realize a multilayer ceramic capacitor corresponding to a reduced-size housing.

### (Specific Examples of Thickness)

The thickness of the base film 21 may be 1.4 times or more and 3.0 times or less of the inner plating film 24. This makes it possible to achieve both electrical conductivity with the internal electrode layer 10 and mountability to a reduced-size housing.

When the thickness of the base film 21 in the lamination direction is 1.4 times or less of the inner plating film 24, sufficient electrical conductivity performance with the internal electrode layer 10 cannot be secured, and when the thickness of the base film 21 is 3.0 times or more, the thickness of the entire external electrode 20 increases, thereby impairing mountability to a reduced-size housing.

The thickness of the base film 21 may be 1.4 times or more and 3.0 times or less of the outer plating film 25. By setting the thickness of the base film 21 to 1.4 times or more and 3.0 times or less, both electrical conductivity with the internal electrode layer 10 and mountability to a reduced-size housing may be achieved.

When the thickness of the base film 21 is 1.4 times or less of the outer plating film 25, sufficient electrical conductivity performance with the internal electrode layer 10 cannot be secured, and when the thickness of the base film 21 is 3.0 times or more, the thickness of the entire external electrode 20 increases, which impairs mountability to a reduced-size housing.

The film thickness of the base film 21 may be 0.4 times or more and 0.6 times or less of the total film thickness of the inner plating film 24 and the outer plating film 25.

By setting the film thickness of the base film 21 to 0.4 times or more and 0.6 times or less, it is possible to achieve both electrical conductivity with the internal electrode layer 10 and mountability to a reduced-size housing.

When the film thickness of the base film 21 is 0.4 times or less, sufficient electrical conductivity performance with the internal electrode layer 10 cannot be secured, and when the film thickness of the base film 21 is 0.6 times or more, the thickness of the entire external electrode 20 increases, which impairs mountability to a reduced-size housing.

The thickness of the inner plating film 24 may be 0.2 times or more and 0.3 times or less of the total film thickness of the base film 21, the inner plating film 24, and the outer plating film 25.

By setting the thickness of the inner plating film 24 to 0.2 times or more and 0.3 times or less, it is possible to achieve both solder leaching resistance and mountability to a reduced-size housing.

When the thickness of the inner plating film 24 is 0.2 times or less, it is not possible to sufficiently reduce or prevent solder leaching of the base film 21, and when the thickness of the inner plating film 24 is 0.3 times or more, the thickness of the entire external electrode 20 increases, which impairs mountability to a reduced-size housing.

The thickness of the outer plating film 25 may be 0.2 times or more and 0.3 times or less of the total film thickness of the base film 21, the inner plating film 24, and the outer plating film 25.

By setting the thickness of the outer plating film 25 to 0.2 times or more and 0.3 times or less, it is possible to achieve both solder wettability with the inner plating film 24 and mountability to a reduced-size housing.

When the thickness of the outer plating film 25 is 0.2 times or less, solder spreading to the inner plating film 24 is not sufficient, and when the thickness of the outer plating film 25 is 0.3 times or more, the thickness of the entire external electrode 20 increases, which impairs mountability to a reduced-size housing.

### (Claim 2)

The thickness of the base film 21 may be 1.0 μm or more and 6.0 μm or less. By setting the thickness to 1.0 μm or more and 6.0 μm or less, it is possible to achieve both electrical conductivity with the internal electrode layer 10 and mountability to a reduced-size housing.

When the thickness of the base film 21 is 1.0 μm or less, sufficient electrical conductivity with the internal electrode layer 10 cannot be secured, and when the thickness is 6.0 μm or more, the thickness of the entire external electrode 20 increases, which impairs mountability to a reduced-size housing.

The thickness of the inner plating film 24 may be 0.7 μm or more and 2.0 μm or less. By setting the thickness to 0.7 μm or more and 2.0 μm or less, it is possible to achieve both solder leaching resistance and mountability to a reduced-size housing.

When the thickness of the inner plating film 24 is 0.7 μm or less, it is not possible to sufficiently reduce or prevent solder leaching of the base film 21, and when the thickness is 2.0 μm or more, the thickness of the entire external electrode 20 increases, which impairs mountability to a reduced-size housing.

The thickness of the outer plating film 25 may be 0.7 μm or more and 2.0 μm or less. By setting the thickness to 0.7 μm or more and 2.0 μm or less, it is possible to achieve both solder wettability to the inner plating film 24 and mountability to a reduced-size housing.

When the thickness of the outer plating film 25 is 0.7 μm or less, it is not possible to sufficiently ensure solder wettability to the inner plating film 24, and when the thickness is 2.0 μm or more, the thickness of the entire external electrode 20 increases, which impairs mountability to a reduced-size housing.

The total thickness of the base film 21, the inner plating film 24, and the outer plating film 25 may be 2.4 μm or more and 10 μm or less.

By setting the total thickness to 2.4 μm or more and 10 μm or less, electrical conductivity to the base film 21 and the internal electrode layer 10, solder wettability to the inner plating film 24, and prevention of solder leaching, as well as mountability to a reduced-size housing may be achieved.

When the thickness is 2.4 μm or less, electrical conductivity to the base film 21 and the internal electrode layer 10 cannot be ensured, and solder wettability to the inner plating film 24 and prevention of solder leaching cannot be achieved. When the thickness is 10 μm or more, mountability to a reduced-size housing is impaired.

In the multilayer ceramic component 1 of the present disclosure, the thickness in the lamination direction of the external electrode 20 on the first main surface and the second main surface, the thickness in the length direction of the external electrode 20 on the first end surface and the second end surface, and the thickness in the width direction of the external electrode 20 on the first lateral surface and the second lateral surface are each small, such that it is possible to realize a multilayer ceramic capacitor corresponding to a reduced-size housing.

### (Size of Multilayer Ceramic Component)

The size of the multilayer ceramic component 1 is not particularly limited. The size of the multilayer ceramic component 1 can be, for example, as follows. The dimension of the multilayer ceramic component 1 including the multilayer body 2 and the external electrode 20 in the length direction L is defined as the L dimension. The L dimension may be 0.25 mm or more and 1.0 mm or less. The dimension of the multilayer ceramic component 1 including the multilayer body 2 and the external electrode 20 in the lamination direction T is defined as the T dimension. The T dimension may be 0.125 mm or more and 0.5 mm or less. The dimension of the multilayer ceramic component 1 including the multilayer body 2 and the external electrode 20 in the width direction W is defined as the W dimension. The W dimension may be 0.125 mm or more and 0.5 mm or less. In addition, the length of each portion of the multilayer body 2 and the external electrode 20 can be measured with a micrometer or an optical microscope.

In the present embodiment, the multilayer ceramic component 1 has been described as an example of a two-terminal multilayer ceramic capacitor. However, the multilayer ceramic component 1 is not limited to a two-terminal multilayer ceramic capacitor, and may be a multi-terminal multilayer ceramic capacitor having three or more terminals.

### (Method for Measuring Thickness)

A method for measuring thickness will be described. The measurement positions are as follows. The thickness of the first external electrode 20a and each layer included in the first external electrode 20a on the first main surface 3a is defined as the thickness of the thickest portion on the first main surface 3a. Similarly, the thickness of the second external electrode 20b and each layer included in the second external electrode 20b on the second main surface 3b is defined as the thickness of the thickest portion on the second main surface 3b.

The thickness of the external electrode 20 on the lateral surface 4 is defined as the thickness of the thickest portion on the lateral surface 4. Similarly, the thickness of the external electrode 20 on the end surface 5 is defined as the thickness of the thickest portion on the end surface 5.

These thicknesses are the thicknesses measured in the LT cross section in the middle in the width direction W. In addition, the thickness can be measured by a scanning electron microscope (SEM) after exposing the measurement target location by cross-sectional polishing.

### (Method of Manufacturing Multilayer Ceramic Component)

Next, a method of manufacturing the multilayer ceramic component will be described using the multilayer ceramic component 1 as an example.

### (Fabrication of Multilayer Block)

A ceramic sheet and an electrically conductive paste for manufacturing internal electrode layers are prepared. The ceramic sheet and the electrically conductive paste for manufacturing internal electrode layers include a binder and a solvent. Known organic binders and organic solvents can be used for the binder and the solvent. The electrically conductive paste for manufacturing internal electrode layers is printed on the ceramic sheet in a predetermined pattern by, for example, screen printing or gravure printing to form the pattern of the internal electrode layer 10. A predetermined number of ceramic sheets for manufacturing outer layer portions on which the pattern of the internal electrode layer 10 is not printed are laminated, ceramic sheets on which the pattern of the internal electrode layer 10 is printed are sequentially laminated thereon, and a predetermined number of ceramic sheets for manufacturing the other outer layer portion are laminated thereon to fabricate a multilayer sheet. The multilayer sheet is pressed in the lamination direction by a means such as a hydrostatic press to fabricate a multilayer block.

### (Fabrication of Multilayer Chip)

The multilayer block is cut to a predetermined size to cut out a multilayer chip. At this time, corner portions and ridge portions of the multilayer chip may be rounded by barrel polishing or the like. The multilayer chip is fired to form the multilayer body 2.

### (Firing)

Next, the multilayer chip is fired to fabricate the multilayer body 2. The firing temperature depends on the materials of the dielectric layer 7 and the internal electrode layer 10, and may be 900° C. or more and 1400° C. or less.

### (External Electrode)

Next, the formation of the external electrode 20 will be described.

### (Base Film)

An electrically conductive paste that forms the base film 21 is applied to the two end surfaces 5 of the multilayer body 2 to form the base film 21. In order to form a fired layer, an electrically conductive paste including a glass component and metal is applied by a method such as dipping, and then firing treatment is performed to form the base film 21. The temperature of the firing treatment at this time may be 500° C. or more and 900° C. or less. The time of the firing treatment at this time may be 30 minutes or more and 2 hours or less. The atmosphere of the firing treatment at this time may be a reducing atmosphere including H₂O or H₂, for example.

Next, a plating film is formed on the surface of the base film 21. In the present embodiment, a Ni plating film is formed on the fired layer. This Ni plating film functions as the inner plating film 24. Next, a Sn plating film is formed on the Ni plating film. This Sn plating film functions as the outer plating film 25. The Ni plating film and the Sn plating film are sequentially formed by, for example, a barrel plating method. In this manner, the multilayer ceramic component 1 is obtained.

Although embodiments of the present disclosure have been described above, the present invention is not limited to the above-described embodiments, and various changes and modifications thereto can be made.

### EXPLANATION OF REFERENCE NUMERALS

1 multilayer ceramic component
2 multilayer body
3 main surface
4 lateral surface
5 end surface
7 dielectric layer
10 internal electrode layer
11 counter electrode portion
12 extension electrode portion
20 external electrode
21 base film
24 inner plating film (Ni plating film, plating film covering base film)
25 outer plating film (Sn plating film)
27 end surface external electrode
28 main surface external electrode
29 lateral surface external electrode
31 first main surface base film
34 first main surface inner plating film
35 first main surface outer plating film
41 second main surface base film
44 second main surface inner plating film
45 second main surface outer plating film
51 first end surface base film
54 first end surface inner plating film
55 first end surface outer plating film
61 second end surface base film
64 second end surface inner plating film
65 second end surface outer plating film
71 first lateral surface base film
74 first lateral surface inner plating film
75 first lateral surface outer plating film
81 second lateral surface base film
84 second lateral surface inner plating film
85 second lateral surface outer plating film
90 substrate
92 sealing material
T lamination direction
L length direction
W width direction

1. A multilayer ceramic component comprising:
a multilayer body including a plurality of dielectric layers and a plurality of internal electrode layers that are laminated, a first main surface and a second main surface opposed to each other in a lamination direction, a first lateral surface and a second lateral surface opposed to each other in a width direction orthogonal to the lamination direction, and a first end surface and a second end surface opposed to each other in a length direction orthogonal to the lamination direction and the width direction; and
external electrodes each provided on a corresponding one of the first end surface and the second end surface, and connected to the plurality of internal electrode layers, wherein
the external electrodes each extend to the first main surface and the second main surface,
the external electrodes each include
a base film in contact with the plurality of internal electrode layers,
an inner plating film in contact with the base film, and
an outer plating film in contact with the inner plating film,
a film thickness of the base film is greater than a film thickness of the inner plating film or the outer plating film, the film thickness of the base film is 1.4 times or more and 3.0 times or less of a film thickness of the inner plating film,
the film thickness of the base film is 1.4 times or more and 3.0 times or less of a film thickness of the outer plating film,
the film thickness of the base film is 0.4 times or more and 0.6 times or less of a total film thickness of the base film, the inner plating film, and the outer plating film,
a film thickness of the inner plating film is 0.2 times or more and 0.3 times or less of the total film thickness of the base film, the inner plating film, and the outer plating film, and
a film thickness of the outer plating film is 0.2 times or more and 0.3 times or less of the total film thickness of the base film, the inner plating film, and the outer plating film.

2. The multilayer ceramic component according to claim 1, wherein
the film thickness of the base film is 1 μm or more and 6 μm or less,
the film thickness of the inner plating film is 0.7 μm or more and 2 μm or less,
the film thickness of the outer plating film is 0.7 μm or more and 2 μm or less, and
the total film thickness of the base film, the inner plating film, and the outer plating film is 2.4 μm or more and 10 μm or less.

3. The multilayer ceramic component according to claim 1, wherein the inner plating film comprises a Ni plating film.

4. The multilayer ceramic component according to claim 3, wherein the outer plating film comprises a Sn plating film formed on the Ni plating film.

5. The multilayer ceramic component according to claim 1, wherein the outer plating film includes a Sn plating film.

6. The multilayer ceramic component according to claim 1, wherein the base film is a fired layer including a glass component and a metal.

7. The multilayer ceramic component according to claim 6, wherein the metal of the fired layer includes at least one selected from the group consisting of Cu, Ni, Ag, Pd, an Ag—Pd alloy, and Au.

8. The multilayer ceramic component according to claim 1, wherein the external electrodes each further extend to the first lateral surface and the second lateral surface.

9. The multilayer ceramic component according to claim 1, wherein the plurality of internal electrode layers comprise Ni.

10. The multilayer ceramic component according to claim 1, wherein a dimension of the multilayer ceramic component in the length direction is 0.25 mm or more and 1.0 mm or less.

11. The multilayer ceramic component according to claim 1, wherein a dimension of the multilayer ceramic component in the lamination direction is 0.125 mm or more and 0.5 mm or less.

12. The multilayer ceramic component according to claim 10, wherein a dimension of the multilayer ceramic component in the lamination direction is 0.125 mm or more and 0.5 mm or less, and a dimension of the multilayer ceramic component in the width direction is 0.125 mm or more and 0.5 mm or less.

13. The multilayer ceramic component according to claim 1, wherein the component is a multilayer ceramic capacitor.

14. A multilayer ceramic component comprising:
a multilayer body including a plurality of dielectric layers and a plurality of internal electrode layers that are laminated, a first main surface and a second main surface opposed to each other in a lamination direction, a first lateral surface and a second lateral surface opposed to each other in a width direction orthogonal to the lamination direction, and a first end surface and a second end surface opposed to each other in a length direction orthogonal to the lamination direction and the width direction; and
external electrodes each provided on a corresponding one of the first end surface and the second end surface, and connected to the plurality of internal electrode layers,
wherein the external electrodes each include a base film, an inner plating film on the base film, and an outer plating film on the inner plating film,
wherein a film thickness of the base film is 1.4 times or more and 3.0 times or less of a film thickness of the inner plating film,
wherein the film thickness of the base film is 1.4 times or more and 3.0 times or less of a film thickness of the outer plating film, and
wherein the film thickness of the base film is 0.4 times or more and 0.6 times or less of a total film thickness of the base film, the inner plating film, and the outer plating film.

15. The multilayer ceramic component according to claim 14, wherein the inner plating film comprises a Ni plating film and the outer plating film comprises a Sn plating film.

16. The multilayer ceramic component according to claim 14, wherein the film thickness of the base film is 1 μm or more and 6 μm or less, the film thickness of the inner plating film is 0.7 μm or more and 2 μm or less, and the film thickness of the outer plating film is 0.7 μm or more and 2 μm or less.

17. The multilayer ceramic component according to claim 14, wherein the external electrodes each further extend to the first lateral surface and the second lateral surface.

18. A method of manufacturing a multilayer ceramic component, the method comprising:
fabricating a multilayer body by laminating and firing a plurality of dielectric layers and a plurality of internal electrode layers, the multilayer body having a first end surface and a second end surface;
forming a base film on each of the first end surface and the second end surface by applying an electrically conductive paste and firing the paste, the base film being in contact with the plurality of internal electrode layers;
forming an inner plating film on the base film by a first plating process;
forming an outer plating film on the inner plating film by a second plating process; and
controlling the forming processes such that:
a film thickness of the base film is 1.4 times or more and 3.0 times or less of a film thickness of the inner plating film,
the film thickness of the base film is 1.4 times or more and 3.0 times or less of a film thickness of the outer plating film,
the film thickness of the base film is 0.4 times or more and 0.6 times or less of a total film thickness of the base film, the inner plating film, and the outer plating film, a film thickness of the inner plating film is 0.2 times or more and 0.3 times or less of the total film thickness, and
a film thickness of the outer plating film is 0.2 times or more and 0.3 times or less of the total film thickness.

19. The method according to claim 18, wherein
further controlling the forming processes such that
the film thickness of the base film is 1 μm or more and 6 μm or less, the film thickness of the inner plating film is 0.7 μm or more and 2 μm or less, and the film thickness of the outer plating film is 0.7 μm or more and 2 μm or less.

20. The method according to claim 18, wherein the first plating process forms a Ni plating film and the second plating process forms a Sn plating film.
